(19) United States
(12) Patent Application Publication
(10) Pub. No.: US 2003/0018924 A1
(43) Pub. Date: Jan. 23, 2003

(54) Method and system for providing clock signal to a CSR/RMON block

(76) Inventor: Saleem Chisty Mohammad, Fremont, CA (US)

Correspondence Address: WILDMAN, HARROLD, ALLEN & DIXON, 225 WEST WACKER DRIVE, CHICAGO, IL, 60606, US

(21) Appl. No.: 09/910,171

(22) Filed: Jul. 20, 2001

(51) Int. Cl. G06F 1/04; G06F 1/06

(52) U.S. Cl. 713/500

(57) ABSTRACT

A method and system in which a detection is made that an operation on a register and counter block is needed. A clock signal to the register and counter block is enabled, and the operation is executed on the register and counter block through employment of the clock signal.

### BACKGROUND

The present invention is related generally to a method and system for reducing power expenditure in an electronic device and more particularly to a method and system for providing a clock signal to a device which is disabled when not needed.

Ethernet Media access controller (MAC) design generally consists of device logic and a set of registers and counters that are generally designated as a control and status register/remote monitor counter (CSR/RMON) block. As the name indicates, the block includes control registers, status registers, and remote monitor (RMON) counters.

Control registers are typically programmed by an application outside the media access controller core. Control registers store different parameters required to implement core functionality of the media access controller. Status registers store event information which occurs on the Ethernet cable. When an event occurs, one or more of the status registers are updated by the media access controller core. Remote monitor counters store packet statistics that are updated by the media access controller core. A clock signal is used to enable the application to both program and read the registers and remote monitor counters in the CSR/RMON block.

In current systems, the clock signal is applied in a continuous manner to the CSR/RMON block even though programming and reading of the registers and counters accounts for only about 20% to 25% of the total time the media access controller is active. Accordingly, applying the clock signal to the CSR/RMON block in a continuous manner wastes power.

Accordingly, there is a need in the art for a method and system for performing an operation such as programming or reading registers and/or counters in a CSR/RMON block to reduce power consumption by providing a clock signal to a CSR/RMON block substantially only when the CSR/RMON block is having an operation performed thereon.

### SUMMARY OF THE INVENTION

This need is met by a method and system, in accordance with the present invention, in which a clock signal is provided to a CSR/RMON block essentially only when an operation is being performed on the CSR/RMON block.

In accordance with one example of the present invention, a method is provided. In the method it is detected that an operation on a register and counter block is needed. A clock signal to the register and counter block is enabled and the operation on the register and counter block is executed through employment of the clock signal.

In accordance with another example of the present invention, a method for reading a storage component in a Media access control component is provided. In the method, an update to the storage component is detected, a clock signal to the storage component is provided, and the storage component is read through employment of the clock signal.

In accordance with another example of the present invention, a method for programming a control register in a media access control component is provided. In the method, it is determined that the control register needs to be programmed. A clock signal to the control register is provided when the control register needs to be programmed, and the control register is programmed through employment of the clock signal.

In accordance with another example of the present invention, a system is provided. In the system it is detected by a detection unit that an operation on a register and counter block is needed. A clock signal to the register and counter block is enabled by a clock enable unit. The operation on the register and counter block is executed by application logic through employment of the clock signal.

In accordance with another example of the present invention, a system for performing an operation on a storage component in a media access control component is provided. In the system it is detected by clock gating logic that an operation on the storage component is to be performed. A clock signal to the storage component is provided by the clock gating logic in response to a detection that an operation is to be performed. Finally, the operation on the storage component is performed by application logic through employment of the clock signal.

These and other features and advantages of the present invention will become apparent from the following detailed description, accompanying drawings and the appended claims.

### BRIEF DESCRIPTION OF THE DRAWINGS

The foregoing and other advantages of the invention will become apparent upon reading the following detailed description and upon reference to the drawings in which:

FIG. 1 is a block diagram of a system in accordance with one aspect of the present invention, in which a clock signal is selectively applied to a CSR/RMON block.

FIG. 2 is a flow chart illustrating an exemplary method in which one or more status registers in the CSR/RMON block are read by an application.

FIG. 3 is a flow chart illustrating an exemplary method in which one or more RMON counters in the CSR/RMON block are read by an application.

FIG. 4 is a flow chart illustrating an exemplary method in which one or more control registers are programmed by the application.

FIG. 5 is a timing diagram depicting the exemplary methods described in FIGS. 2 and 3.

FIG. 6 is a timing diagram depicting the exemplary method described in FIG. 4.

### DETAILED DESCRIPTION

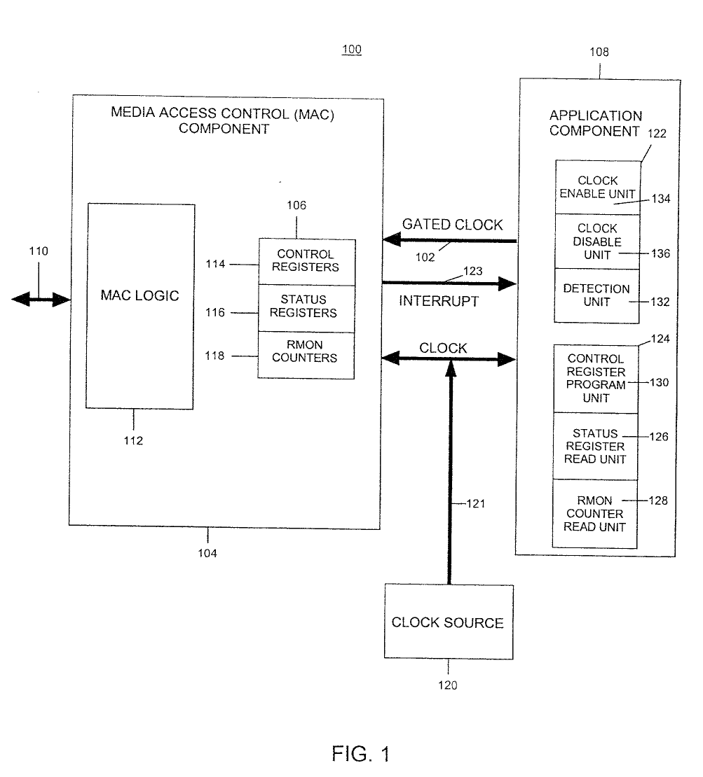

Turning to FIG. 1, system 100, in one example, includes a plurality of components such as computer software and/or hardware components. These components are employed to construct the logic units that are included therein. A number of such components can be combined or divided in system 100. In another example, the constituent elements of the components could also be combined or divided.

System 100, in accordance with one example of the present invention, is shown in FIG. 1 in which a gated clock signal 102 is provided to a media access control (MAC) component 104, and more particularly to a control and status register/remote monitor counter (CSR/RMON) block 106 when an operation is being performed by an application component 108 on the CSR/RMON block 106. The MAC component 104 is connected to an Ethernet bus or cable 110 for communicating with other electronic devices, such as a computer. Device logic, such as MAC logic 112, provides the functionality for the MAC component 104.

The CSR/IMON block 106 contains storage components such as one or more instances of control registers 114, one or more instances of status registers 116, and one or more instances of RMON counters 118. As noted, control registers 114 are typically programmed by application component 108. Control registers 114 store different parameters required to implement the core functionality of the MAC component 104. Status registers 116 store event information which occurs on Ethernet bus or cable 110. When an event occurs, one or more of the status registers are updated by MAC component 104. RMON counters 118 store packet statistics and are also updated by the MAC component 104. Application component 108 reads status registers 116 and RMON counters 118 to receive updates.

A clock source 120 provides a clock signal 121 to MAC component 104. Clock signal 121 is provided in a continuous manner to MAC component 104 and application component 108 for use by the various circuits contained therein. As was stated earlier, however, CSR/RMON block 106 does not need a continuous clock signal.

Therefore, gated clock logic 122 controls gated clock signal 102, which application component 108 selectively employs to perform an operation on CSR/RMON block 106. Gated clock logic 122, in one example, provides the gated clock signal 102 to CSR/RMON block 106 in response to an interrupt signal 123 generated by MAC component 104. MAC component 104 generates interrupt signal 123 when a status register 116 or a RMON counter 118 is updated.

Application component 108 contains application logic 124 that performs operations on CSR/RMON block 106. For instance, application logic 124 may include a status register read unit 126 for reading one or more of status registers 116 through employment of gated clock signal 102. Similarly, application logic 124 may include a RMON counter read unit 128 for reading one or more RMON counters 118 through employment of gated clock signal 102. Finally, application logic 124 may comprise a control register program unit 130 for programming one or more control registers 114 through employment of gated clock signal 102.

Gated clock logic 122 comprises detection unit 132 for detecting that an operation on CSR/RMON block is or needs to be performed. The operation may consist of programming one or more control registers 114, reading one or more status registers 116, and/or reading one or more RMON counters 118. A clock enable unit 134 provides gated clock signal 102 to CSR/RMON block 106 when the operation is to be performed. It should be understood that gated clock signal 102 may be a portion of clock signal 121 generated by the clock source 120. Alternatively, gated clock signal 102 may be provided by another clock source not shown in FIG. 1. A clock signal disable unit 136, in gated clock logic 122, disables the gated clock signal 102 when the operation is completed by the application component 108, or more particularly, application logic 124.

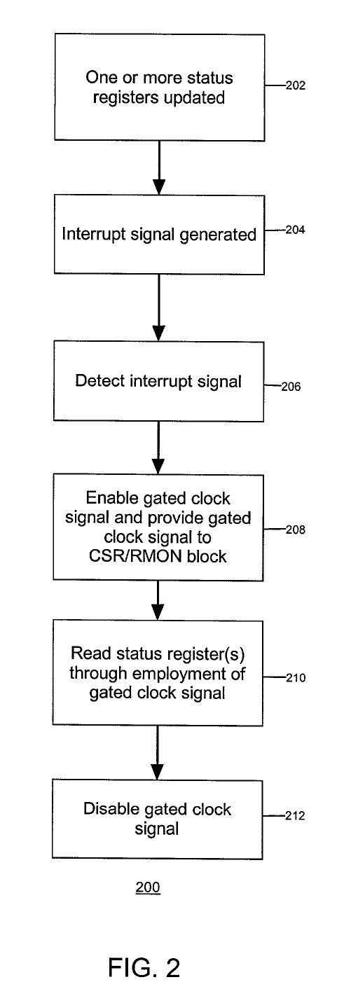

Referring now to FIG. 2, a flow chart is provided illustrating a method 200, in accordance with one aspect of the present invention, for performing an operation on the CSR/RMON block 106. In particular, the flow chart 200 illustrates the reading of status registers 116 in the CSR/RMON block 106 by application component 108. In accordance with one aspect of the present invention, the MAC component 104 updates one or more of status registers 116 in step 202. As noted, MAC component 104 updates the one or more status registers 116 in response to events occurring on Ethernet bus or cable 110.

Interrupt signal 123 is generated by MAC component 104, in response to the one or more status registers 116 being updated, in step 204. Application component 108, or more particularly, detection unit 132, detects interrupt signal 123 in step 206. In step 208, the gated clock signal 102 is enabled by clock enable unit 134 and provided to CSR/RMON block 106. Application component 108, in particular status register read unit 126, reads one or more status registers 116 through employment of gated clock signal 102 in step 210. In response to completion of the reading, clock disable unit 136 then disables gated clock signal at step 212.

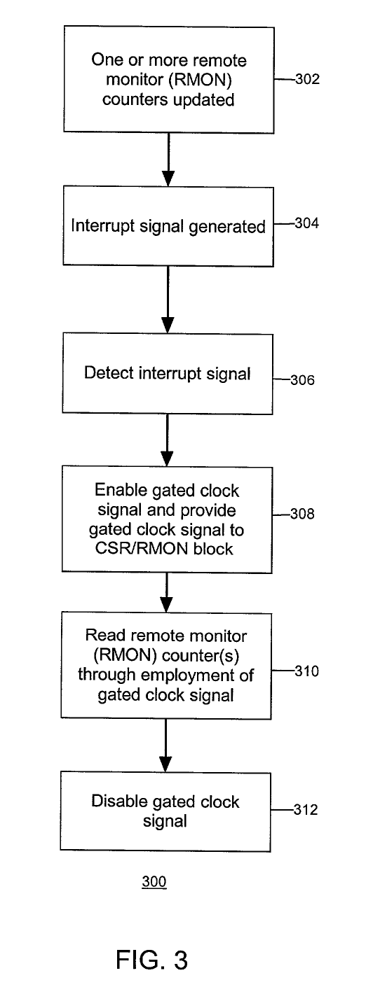

Referring now to FIG. 3, a flow chart is provided illustrating a method 300, in accordance with one aspect of the present invention, for performing an operation on CSR/RMON block 106. In particular, the flow chart illustrates the reading of one or more RMON counters 118 in CSR/RMON block 106 by the application component 108. In accordance with one aspect of the present invention, MAC component 104 updates one or more of RMON counters 118 in step 302. As noted, MAC component 104 updates the RMON counters 118 with packet statistics.

Interrupt signal 123 is generated by the MAC component 104 in step 304 in response to the one or more of RMON counters 118 being updated. Application component 108, or more particularly, detection unit 132, detects interrupt signal 123 at step 306. In step 308 gated clock signal 102 is enabled by the clock enable unit 134 and provided to the CSR/RMON block 106. Application component 108, in particular RMON counter read unit 128, reads the one or more RMON counters 118 through employment of gated clock signal 102 at step 310. In response to completion of the reading, clock disable unit 136 then disables gated clock signal 102 in step 312.

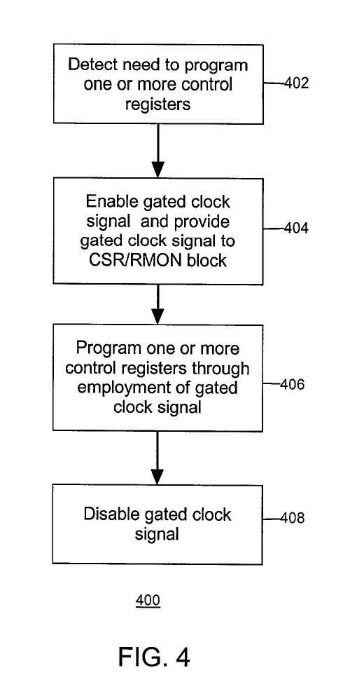

Referring now to FIG. 4, a method for system 100, in accordance with one aspect of the present invention, for programming one or more of control registers 114 is shown. In step 402, a need to program one or more control registers 114 is detected. In response thereto, clock enable unit 134 enables gated clock signal 102 and provides gated clock signal 102 to the CSR/RMON block 106 in step 404. Application logic 124, or more specifically, control register program unit 130, then programs the one or more control registers 114 through employment of gated clock signal 102 in step 406. In response to the programming being completed, clock disable unit 136 disables gated clock signal 102 in step 408.

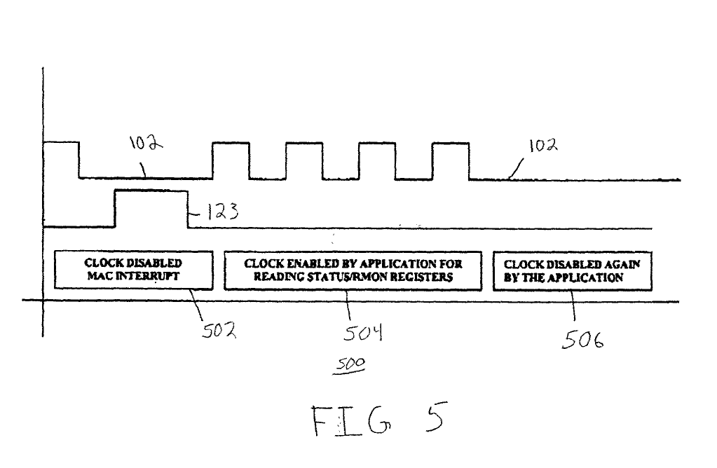

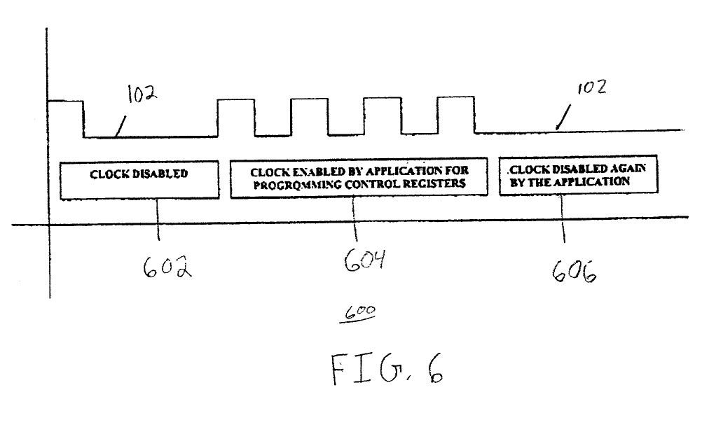

FIGS. 5 and 6 are graphical illustrations 500 and 600 of gated clock signal 102 for reading one or more status registers 116 or one or more RMON counters 118, and for programming one or more control registers 114 respectively.

In FIG. 5, gated clock signal 102 is disabled in time period 502 until interrupt signal 123 is received from MAC component 104. Gated clock signal 102 is enabled in response to receipt of interrupt signal 123 by application component 108.the one or more status registers 116 and/or the one or more RMON counters 118 are read in time period 504. In time period 506, gated clock signal 102 is disabled by application component 104 after the status registers 116 and/or the RMON counters 118 have been read.

In FIG. 6, gated clock signal 102 is disabled for time period 602. Gated clock signal 102 is then enabled by the application component 108 for time period 604 for programming one or more control registers 114. In time period 606, gated clock signal 102 is again disabled by the application component 108.

While the invention may be susceptible to various modification and alternative forms, specific embodiments have been shown by way of example, in the drawings, and have been described in detail herein. However, it should be understood that the invention is not intended to be limited to the particular forms disclosed. Rather, the invention is to cover all modifications, equivalents, and alternatives falling within the sphere and the scope of the invention as defined by the following appended claims:

1. A method, comprising the steps of:
detecting that an operation on a register and counter block is needed;
enabling a clock signal to the register and counter block; and
executing the operation on the register and counter block through employment of the clock signal.

2. The method of claim 1, further comprising the step of:
disabling the clock signal to the register and counter block after execution of the operation.

3. The method of claim 1, wherein the executing step comprises the step of:
programming a control register in the register and counter block.

4. The method of claim 1, wherein the register and counter block is in a media access control (MAC) component.

5. The method of claim 4, wherein the detecting step comprises the step of:
detecting an interrupt signal from the media access control component.

6. The method of claim 5, wherein the enabling step comprises employing the interrupt signal to enable the clock signal.

7. The method of claim 1, wherein the executing step comprises:
reading at least one of a remote monitor (RMON) counter and a status register in the register and counter block.

8. A method for reading a storage component in a media access control component comprising the steps of:
detecting an update to the storage component;
providing a clock signal to the storage component in response to detection of the update; and
reading the storage component through employment of the clock signal.

9. The method of claim 8, wherein the storage component is one of a status register and a remote monitor (RMON) counter.

10. The method of claim 8, further comprising the step of:
disabling the clock signal after the storage component has been read.

11. A method for programming a storage component in a media access control component comprising:
determining that the storage component needs to be programmed;
providing a clock signal to the control register in response to a determination that the storage component needs to be programmed; and
programming the storage component through employment of the clock signal.

12. The method of claim 11, further comprising:
disabling the clock signal after the storage component has been programmed.

13. The method of claim 11, wherein the storage component is a control register.

14. A system comprising:
a detection unit that detects that an operation on a register and counter block is needed;
a clock enable unit that enables a clock signal to the register and counter block in response to a detection that the operation is needed; and
application logic that executes the operation on the register and counter block through employment of the clock signal.

15. The system of claim 14, further comprising:
a clock disable unit that disables the clock signal to the register and counter block after execution of the operation.

16. The system of claim 14, wherein the application logic comprises:
a control register program unit that programs a control register in the register and counter block.

17. The system of claim 14, wherein the register and counter block is part of a media access control component.

18. The system of claim 17, wherein the detection unit comprises:
a logic component that detects an interrupt signal from the media access control component

19. The system of claim 18, wherein the clock enable unit comprises a logic component that employs the interrupt signal to enable the clock signal.

20. The system of claim 14, wherein the application comprises:
at least one of a status register read unit that reads a status register and a remote monitor counter read unit that reads a remote monitor (RMON) counter.

21. A system for performing an operation on a storage component in a media access control component comprising:
clock gating logic that detects that an operation on the storage component is to be performed and enables a clock signal to the storage component in response to a detection that an operation is to be performed; and
application logic that performs the operation on the storage component through employment of the clock signal.

22. The system of claim 21, wherein the storage component is one of a status register, a control register, and a remote monitor (RMON) counter.

23. The system of claim 20, wherein the clock gating logic disables the clock signal after the operation has been performed.
